(19) United States
(12) Patent Application Publication
(10) Pub. No.: US 2024/0339796 A1
(43) Pub. Date: Oct. 10, 2024

(54) Unlocking Tool

(71) Applicants: SIBAS Electronics (Xiamen) Co. Ltd., Xiamen City (CN); Tyco Electronics (Shanghai) Co., Ltd., Shanghai (CN)

(72) Inventors: Qiang Yuan, Xiamen (CN); Liqiang (Gino) Yao, Shanghai (CN); Yong (Chris) Wang, Shanghai (CN); Lei Wang, Xiamen (CN); Yingchun (David) Wang, Shanghai (CN)

(73) Assignees: SIBAS Electronics (Xiamen) Co. Ltd., Xiamen City (CN); Tyco Electronics (Shanghai) Co., Ltd., Shanghai (CN)

(21) Appl. No.: 18/627,502

(22) Filed: Apr. 5, 2024

(30) Foreign Application Priority Data
Apr. 7, 2023 (CN) 202320749235.5

(51) Int. Cl. H01R 43/22

(52) U.S. Cl. CPC H01R 43/22

(57) ABSTRACT

An unlocking tool for unlocking a terminal of a connector includes a handle portion having a pair of handle halves that can be opened and closed, a tool head having a pair of tool head halves, each of the tool head halves is fixed to an end of one of the handle halves, and a cable through hole axially penetrating through the handle portion and the tool head. The cable through hole is configured to accommodate a cable. The tool head halves combine to form a cylindrical tool head when the handles halves are closed. The cylindrical tool head is insertable into an insertion hole in the connector to drive a terminal locking member of the connector to an unlocking position separate from the terminal.

### CROSS-REFERENCE TO RELATED APPLICATION

This application claims the benefit of the filing date under 35 U.S.C. § 119 (a)-(d) of Chinese Patent Application No. 202320749235.5, filed on Apr. 7, 2023.

### FIELD OF THE INVENTION

The present invention relates to an unlocking tool, in particular to an unlocking tool for unlocking a terminal in a connector.

### BACKGROUND

An unlocking tool for unlocking a terminal in a connector typically includes a handle and a tool head connected to one end of the handle. The cross-section of the tool head is C-shaped, used to insert into an insertion hole in a top cover of the connector to drive a terminal locking member of the connector to an unlocked position separated from the terminal.

Before inserting the tool head into the insertion hole of the connector, it is necessary to bend the cable connected to the terminal to one side to prevent the cable from interfering with the unlocking tool. Then, it is necessary to observe the position of three elastic locking pieces of the terminal locking member through the insertion hole to align the tool head with the three elastic locking pieces of the terminal locking member and insert it. The unlocking operation of existing unlocking tools is therefore very complex and difficult.

### SUMMARY

An unlocking tool for unlocking a terminal of a connector includes a handle portion having a pair of handle halves that can be opened and closed, a tool head having a pair of tool head halves, each of the tool head halves is fixed to an end of one of the handle halves, and a cable through hole axially penetrating through the handle portion and the tool head. The cable through hole is configured to accommodate a cable. The tool head halves combine to form a cylindrical tool head when the handles halves are closed. The cylindrical tool head is insertable into an insertion hole in the connector to drive a terminal locking member of the connector to an unlocking position separate from the terminal.

### BRIEF DESCRIPTION OF THE DRAWINGS

Features of the present invention will become more apparent by describing in detail exemplary embodiments thereof with reference to the accompanying drawings, in which:

FIG. 1 shows a cross-sectional view of a connector according to an exemplary embodiment;

FIG. 2 shows an illustrative perspective view of a terminal locking member of the connector shown in FIG. 1;

FIG. 3 shows an illustrative perspective view of an unlocking tool according to an exemplary embodiment, wherein the unlocking tool is in a closed state;

FIG. 4 shows an illustrative perspective view of the unlocking tool according to an exemplary embodiment, wherein the unlocking tool is in an opened state;

FIG. 5 shows an illustrative exploded view of an unlocking tool according to an exemplary embodiment;

FIG. 6 shows an illustrative perspective view of one handle half and one tool head half of an unlocking tool according to an exemplary embodiment;

FIG. 7 shows an illustrative perspective view of the other handle half and the other tool head half of the unlocking tool according to an exemplary embodiment;

FIG. 8 shows an illustrative view of opening the unlocking tool to place the connector cable into the cable through hole of the unlocking tool;

FIG. 9 shows an illustrative view of the cable of the connector being placed into the cable through hole of the opened unlocking tool;

FIG. 10 shows an illustrative view of closing the unlocking tool and inserting the tool head into the insertion hole of the connector after the cable is placed into the cable through hole of the unlocking tool; and

FIG. 11 shows a sectional view of the unlocking tool and connector shown in FIG. 10.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

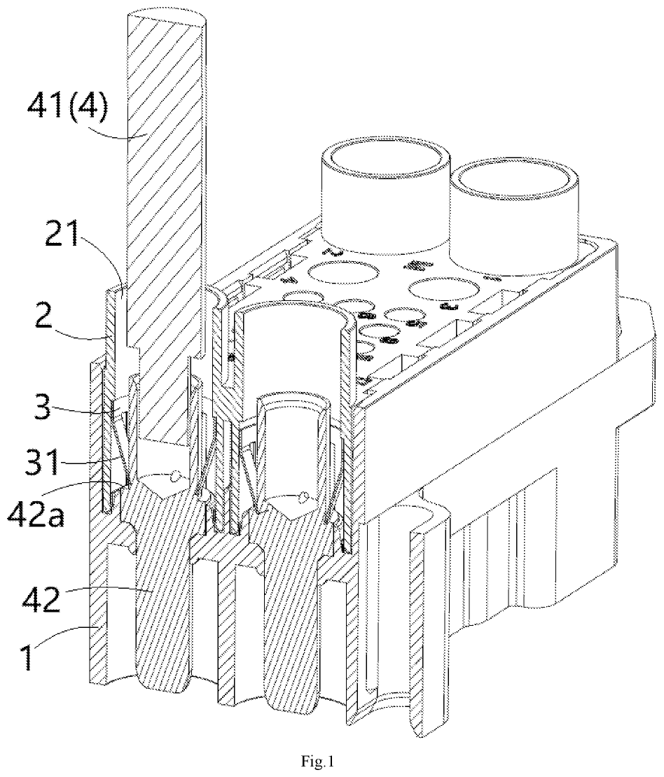

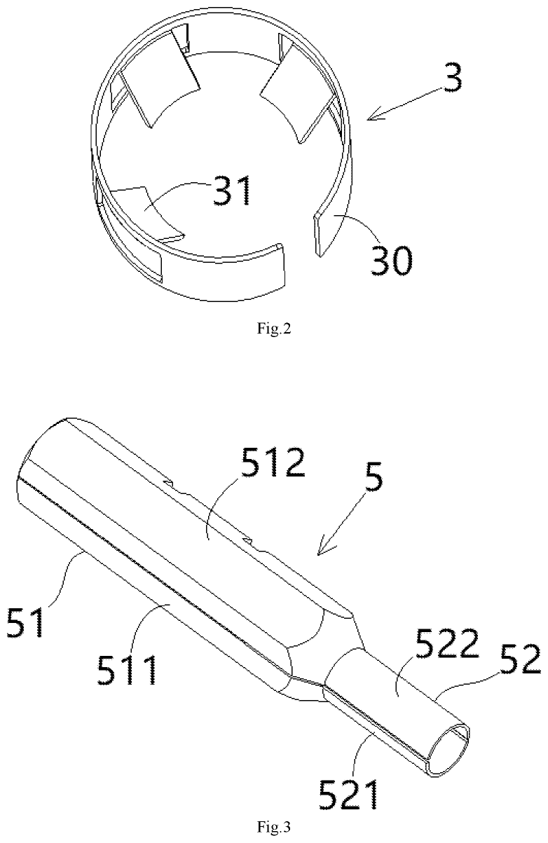

As shown in FIGS. 1 and 2, in the illustrated embodiments, the connector comprises a housing 1, a top cover 2, a terminal locking member 3, and a cable assembly 4. The top cover 2 is installed on a top opening of the housing 1, and the terminal locking member 3 is installed in an insertion hole 21 in the top cover 2. The cable assembly 4 includes a cable 41 and a terminal 42. The terminal 42 is crimped onto one end of cable 41. The terminal 42 is inserted into the housing 1 through the insertion hole 21 in the top cover 2.

As shown in FIGS. 1 and 2, in the illustrated embodiments, the terminal locking member 3 comprises a cylindrical body 30 and three elastic locking pieces 31 located within the cylindrical body 30. Three elastic locking pieces 31 are pressed against a radial step surface 42a on the terminal 42 to lock the terminal 42 in the housing 1. Therefore, when pulling out the cable assembly 4 from housing 1, it is necessary to first use an unlocking tool 5 to push the three elastic locking pieces 31 of terminal locking member 3 to the unlocking position separated from the radial step surface 42a on the terminal 42.

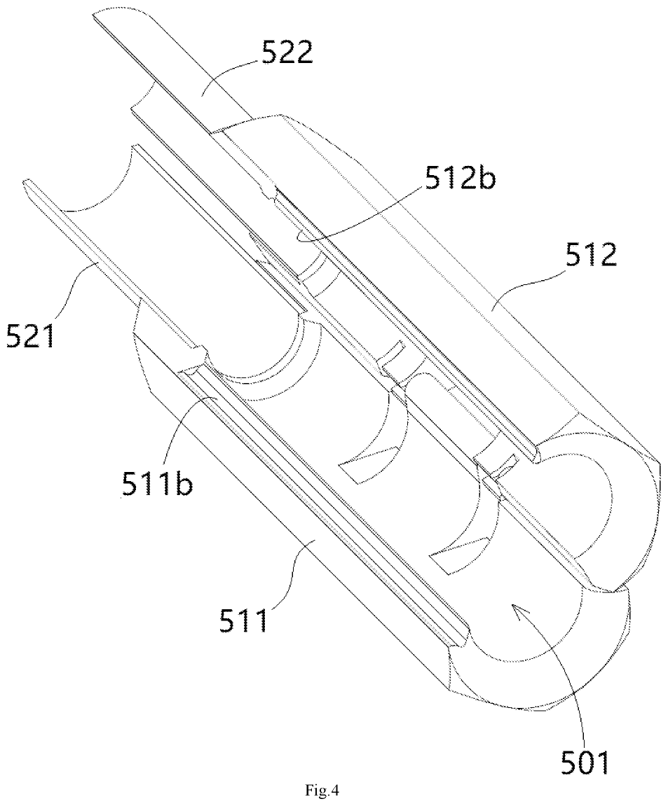

As shown in FIG. 3, in an exemplary embodiment of the present invention, an unlocking tool 5 is disclosed for unlocking the terminal 42 of the connector as shown in FIG. 1. The unlocking tool 5 includes a handle 51 and a tool head 52. The handle 51 includes two handle halves 511 and 512 that can be opened and closed. The tool head 52 includes two tool head halves 521 and 522 each fixed to one end of the two handle halves 511 and 512. In the illustrated embodiment, the unlocking tool 5 can be opened and closed.

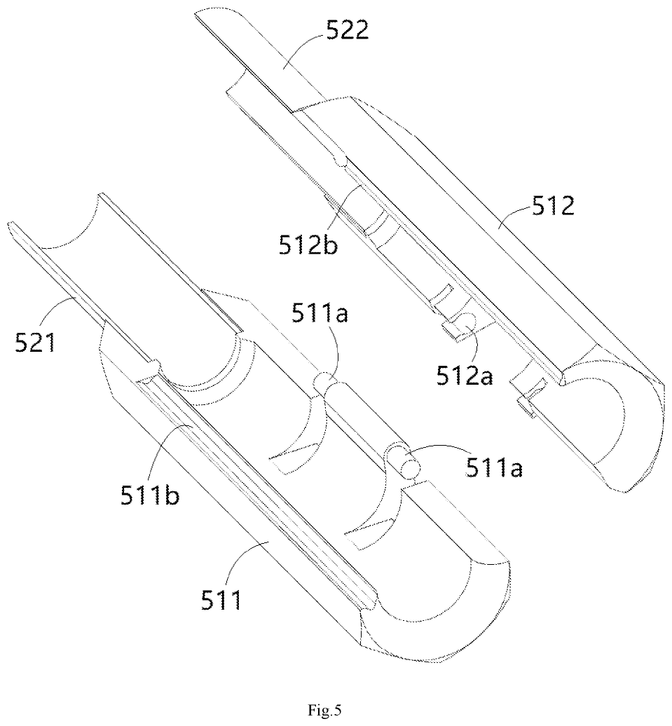

As shown in FIGS. 4 and 8 to 11, in the illustrated embodiments, the unlocking tool 5 has a cable through hole 501 that axially penetrates the handle portion 51 and the tool head 52, and the cable through hole 501 is used to accommodate the cable 41 of the connector.

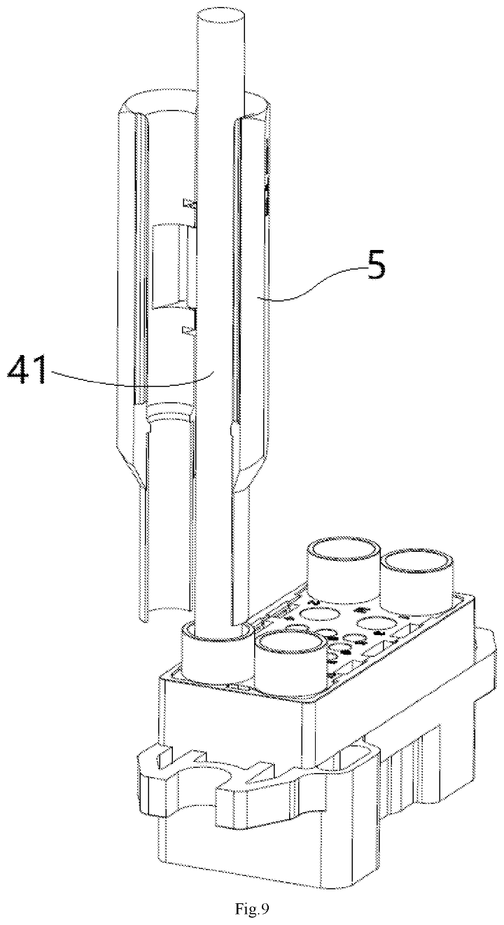

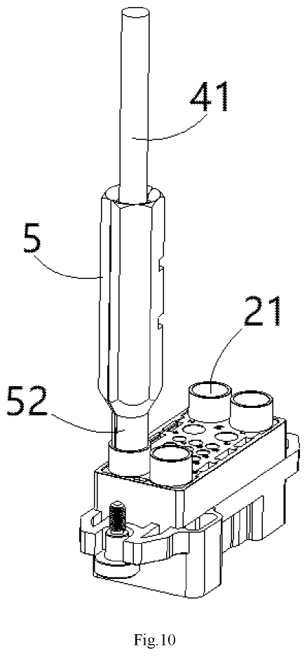

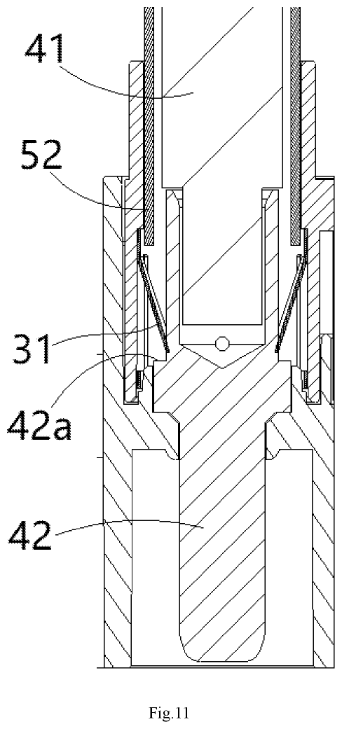

As shown in FIGS. 8 to 11, in the illustrated embodiment, when two handle halves 511 and 512 are closed, the two tool head halves 521 and 522 are combined to form a cylindrical tool head 52. This tool head 52 is used to insert into the insertion hole 21 in the top cover 2 of the connector, in order to drive the terminal locking member 3 of the connector to the unlocked position separate from the terminal 42. When the two handle halves 511 and 512 are opened, the cable 41 of the connector can be placed in the cable through hole 501 from one side of the opened unlocking tool 5, as shown in FIGS. 8 and 9. When the two handle halves 511 and 512 are closed and the cable 41 has been placed in the cable through hole 501, the unlocking tool 5 can be moved axially relative to the cable 41 to allow the unlocking tool 5 to be inserted into the insertion hole 21 in the top cover 2, as shown in FIGS. 10 and 11.

As shown in FIG. 3, in the illustrated embodiments, when two handle halves 511 and 512 are closed, the two handle halves 511 and 512 are combined to form a handle portion 51, and the handle portion 51 is in a hollow cylindrical shape. In the illustrated embodiments, the tool head 52 is typically a metal component, and the handle 51 is typically a plastic component. One end of the tool head half 521 is inserted and bonded to one end of the handle half 511. One end of the other tool head half 522 is inserted and bonded to one end of the other handle half 512.

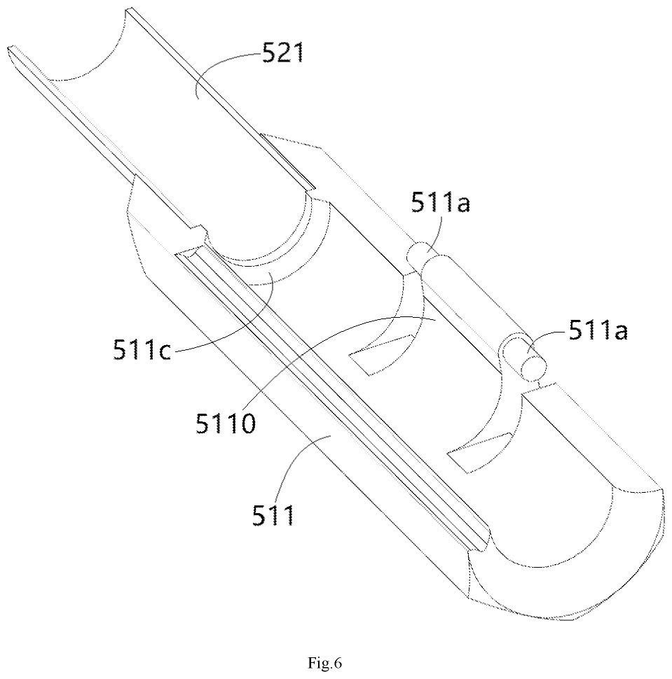

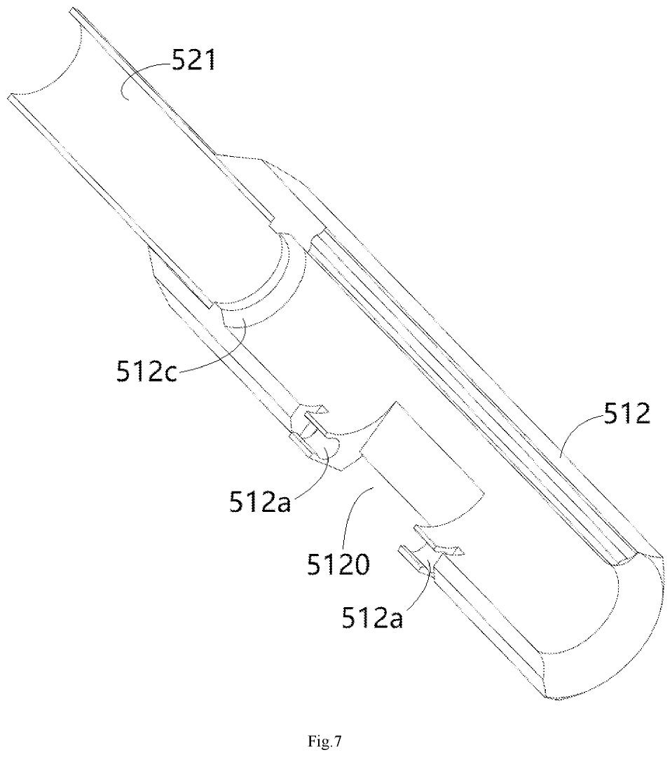

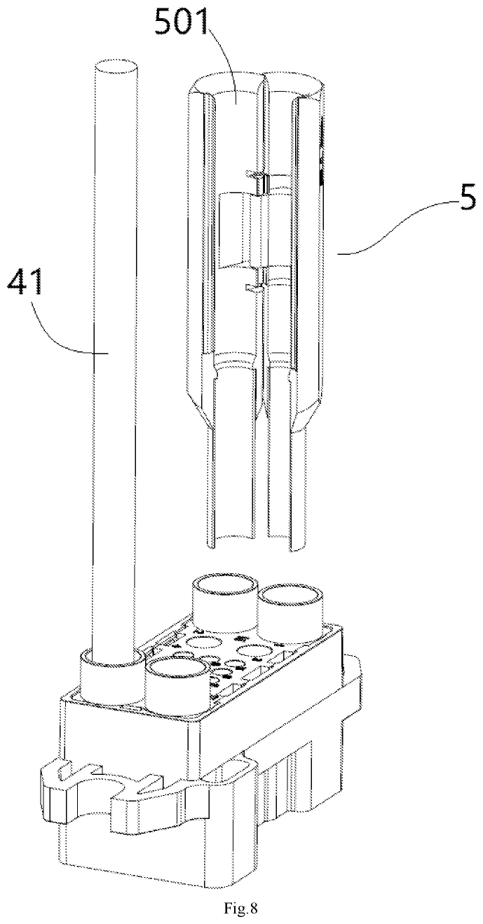

As shown in FIG. 6, in the illustrated embodiments, a semi-circular first positioning flange 511c is formed on the inner circumference wall of one end of one handle half 511, and the end face of one end of one tool head half 521 is pressed against the first positioning flange 511c to axially position one handle half 511. A semi-circular second positioning flange 512c, shown in FIG. 7, is formed on the inner circumferential wall of one end of the other handle half 512, and the end face of one end of the other tool head half 522 is pressed against the second positioning flange 512c to axially position the other handle half 512.

The present disclosure is not limited to the illustrated embodiments. For example, in another exemplary embodiment, one handle half 511 is over molded on one tool head half 521 to fix one end of the one tool head half 521 into one end of the one handle half 511. The other handle half 512 is over molded on the other tool head half 522 to fix one end of the other tool head half 522 into one end of the other handle half 512. In another exemplary embodiment, one tool head half 521 and one handle half 511 are formed into an integral injection molded part. The other tool head half 522 and the other handle half 512 are formed into an integral injection molded part.

In the illustrated embodiment, one side of the two handle halves 511 and 512 is rotatably connected together, allowing the two handle halves 511 and 512 to rotate and open and close. The other sides of the two handle halves 511 and 512 are suitable for being buckled together, so that the two handle halves 511 and 512 can be kept in a closed state.

As shown in FIG. 5, in the illustrated embodiments, a pivot shaft 511a is formed on one side of one handle half 511, and a pivot hole 512a is formed on one side of the other handle half 512. The pivot shaft 511a is engaged with the pivot hole 512a, allowing the two handle halves 511 and 512 to be rotatably opened and closed. The pivot hole 512a has a side opening, and the size of the side opening is smaller than the diameter of the pivot hole 512a, resulting in a C-shaped cross-section of the pivot hole 512a. The pivot shaft 511a is clamped into the pivot hole 512a through the side opening of the pivot hole 512a.

As shown in FIG. 6, in the illustrated embodiments, a tongue portion 5110 is formed on one side of one handle half 511, and pivot shafts 511a are respectively formed on both sides of the tongue portion 5110. A notch 5120 is formed on one side of the other handle half 512, as shown in FIG. 7, and pivot holes 512a are respectively formed at both sides of the notch 5120. The tongue portion 5110 is matched into the notch 5120, and the pivot shaft 511a is engaged in the pivot hole 512a.

As shown in FIG. 5, in the illustrated embodiments, a groove 511b extending axially is formed on the other side of one handle half 511, and a convex rib 512b extending axially is formed on the other side of the other handle half 512. The convex rib 512b is suitable for joining with the groove 511b, so that the other sides of the two handle halves 511 and 512 can be buckled together.

The following will refer to FIGS. 8 to 11 to illustrate the unlocking process of the unlocking tool 5 of the present invention.

Firstly, as shown in FIG. 8, open the two handle halves 511 and 512 of the unlocking tool 5.

Then, as shown in FIG. 9, place the cable 41 of the connector into the cable through hole 501 of the opened unlocking tool 5.

Then, as shown in FIG. 10, close the two handle halves 511 and 512 of the unlocking tool 5.

Then, as shown in FIG. 11, insert the tool head 52 of the closed unlocking tool 5 into the insertion hole 21 of the connector until the end face of the tool head 52 is against the radial step surface 42a of the terminal 42. At this time, the elastic locking pieces 31 of the terminal locking member 3 are pushed to the unlocking position separated from the terminal 42 by the tool head 52.

Finally, pull out the cable assembly 4 outward, so that unlocking tool 5 and the cable assembly 4 are pulled out of the connector together.

In the aforementioned exemplary embodiments, when unlocking the terminal, there is no need to bend the cable and align the tool head with the elastic locking pieces on the terminal locking member. Therefore, the unlocking operation of the unlocking tool of the present invention is simple and easy.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An unlocking tool for unlocking a terminal of a connector, comprising:
a handle portion having a pair of handle halves that can be opened and closed;
a tool head having a pair of tool head halves, each of the tool head halves is fixed to an end of one of the handle halves; and
a cable through hole axially penetrating through the handle portion and the tool head, the cable through hole is configured to accommodate a cable, the tool head halves combine to form a cylindrical tool head when the handles halves are closed, the cylindrical tool head is insertable into an insertion hole in the connector to drive a terminal locking member of the connector to an unlocking position separate from the terminal.

2. The unlocking tool of claim 1, wherein the cable is positionable in the cable through hole from a side of the unlocking tool when the handle halves are opened.

3. The unlocking tool of claim 1, wherein the unlocking tool is movable axially relative to the cable when the handle halves are closed and the cable is in the cable through hole.

4. The unlocking tool of claim 1, wherein the handle halves combine to form the handle portion when the handle halves are closed, the handle portion has a hollow cylindrical shape.

5. The unlocking tool of claim 1, wherein an end of one of the tool head halves is inserted and bonded to the end of one of the handle halves.

6. The unlocking tool of claim 5, wherein a semi-circular first positioning flange is formed on an inner circumferential wall of the end of the one of the handle halves, and an end face of the end of the one of the tool head halves is pressed against the semi-circular first positioning flange to axially position the one of the handle halves.

7. The unlocking tool of claim 6, wherein a semi-circular second positioning flange is formed on an inner circumferential wall of an end of the other of the handle halves, an end face of an end of the other of the tool head halves is pressed against the semi-circular second positioning flange to axially position the other of the handle halves.

8. The unlocking tool of claim 1, wherein one of the handle halves is over molded on one of the tool head halves to fix an end of the one of the tool head halves into the end of the one of the handle halves.

9. The unlocking tool of claim 1, wherein one of the tool head halves and one of the handle head halves are formed into an integral part.

10. The unlocking tool of claim 1, wherein the handle halves are rotatably connected together at a first side of each of the handle halves.

11. The unlocking tool of claim 10, wherein a second side of each of the handle halves is configured to be buckled together to keep the handle halves in a closed state.

12. The unlocking tool of claim 10, wherein a pivot shaft is formed on one of the handle halves and a pivot hole is formed in the other of the handle halves, the pivot shaft engages the pivot hole.

13. The unlocking tool of claim 12, wherein the pivot hole has a side opening, a size of the side opening is less than a diameter of the pivot hole and the pivot hole has a C-shaped cross-section.

14. The unlocking tool of claim 13, wherein the pivot shaft is clamped into the pivot hole through the side opening of the pivot hole.

15. The unlocking tool of claim 12, wherein the one of the handle halves has a tongue portion, the pivot shaft is formed on a pair of sides of the tongue portion.

16. The unlocking tool of claim 15, wherein a notch is formed on the other of the handle halves, the pivot hole is formed on a pair of sides of the notch, the tongue portion is positioned in the notch.

17. The unlocking tool of claim 11, wherein one of the handle halves has a groove and the other of the handle halves has a convex rib, the convex rib engages the groove to buckle the handle halves together.

18. A connector, comprising:
a top cover having an insertion hole;
a terminal locking member in the insertion hole;
a cable assembly including a cable and a terminal, the terminal is positioned in the insertion hole and locked by the terminal locking member; and
an unlocking tool including a handle portion having a pair of handle halves that can be opened and closed, a tool head having a pair of tool head halves, each of the tool head halves is fixed to an end of one of the handle halves, and a cable through hole axially penetrating through the handle portion and the tool head, the cable through hole accommodates the cable, the tool head halves combine to form a cylindrical tool head when the handles halves are closed, the cylindrical tool head is insertable into the insertion hole to drive the terminal locking member to an unlocking position separate from the terminal.
